(19) United States
(12) Patent Application Publication
(10) Pub. No.: US 2021/0007201 A1
(43) Pub. Date: Jan. 7, 2021

(54) DEFENSE SYSTEM FOR BUILDING INTERIOR

(71) Applicant: Mark Wray, Beckley, WV (US)

(72) Inventor: Mark Wray, Beckley, WV (US)

(21) Appl. No.: 16/918,447

(22) Filed: Jul. 1, 2020

Related U.S. Application Data
(60) Provisional application No. 62/869,323, filed on Jul. 1, 2019.

(51) Int. Cl. H05B 47/12; H05B 35/00; H05B 45/10; H05B 39/09; F21S 8/00

(52) U.S. Cl. CPC H05B 47/12; H05B 35/00; F21Y 2115/10; H05B 39/09; F21S 8/033; H05B 45/10

(57) ABSTRACT

A passive defense system that utilizes a plurality of high intensity visible lights to reduce the number of targets in view of attacker(s) or aggressor(s) and to disorient and possibly incapacitate the attacker(s) or aggressor(s). The defense system includes a plurality of high intensity light sources controlled by a control system that can be activated by physical switches, by a central control station, by remote access, or even automatically by a gunshot detection sensor. The light intensity, placement of lights, and strobe effects produce a system to deter or defeat armed attackers or other aggressors.

### CROSS-REFERENCE

This application claims priority to U.S. provisional application No. 62/938,264 filed Jul. 1, 2019 and titled “Defense System for Building Interior,” the entire disclosure of which is incorporated herein by reference for all purposes.

### BACKGROUND

The school and workplace shootings plaguing our nation are increasing in alarming frequency. To date, no solid solution has been found to quell these incidences. Weapons legislation is difficult to pass and may not even be effective in reducing or eliminating these horrific crimes. Any aggressive defensive methods pose their own hazards to students or persons present. Security and technology are expensive and generally not feasible for smaller schools, small businesses, and business operating on tight budgets. Additionally, depending on the building configuration and construction, some buildings are difficult to retrofit with wired security systems.

### SUMMARY

Described herein is a feasible and effective non-lethal, passive defense system for the interior of a building that is designed to incapacitate and/or disorient the attacker with low probability of fatality or permanent injury. The non-lethal defense system is based on weaponized light, utilizing a plurality of high intensity visible lights to reduce the number of targets in view of the attacker(s) and/or to incapacitate the attacker(s) at least temporarily. By tailoring light intensity, strobe effects, and light position, the system deters or defeats armed attacker(s) and other aggressor(s).

The system can be readily installed in any interior space, with little to no remodeling of the structure. Commercial, off-the-shelf hardware can be used in the system.

One particular implementation described herein is a non-lethal defense system for an interior space. The defense system includes a plurality of light sources, each source providing at least 2,000 lumens and the plurality of light sources providing at least 20,000 lumens and 20,000 lux at a distance of 15 feet, the plurality of light sources configured for installation in an interior of a building. The defense system also includes a control system comprising a processor stored in a memory for controlling the operation of the plurality of light sources and an activation system operably connected to the control system to activate the control system, the activation system including an input feature to receive a triggering event.

Another particular implementation described herein is a method of protecting interior space of a building. The method includes positioning a first plurality of light sources in a first zone of the building and positioning a second plurality of light sources in a second zone of the building, each of the light sources providing at least 2,000 lumens and operably connected to a control system. Responsive to a triggering event, the control system activates the first plurality of light sources and the second plurality of light sources to provide at least 20,000 lumens and 20,000 lux at a distance of 15 feet in each of the first zone and the second zone. Responsive to an override event, the control system deactivates the first plurality of light sources, leaving the second plurality of light sources active.

The passive defense system described herein is available now in its constituent parts. Integrating and controlling these components is the unique approach to devising a cost effective and minimally invasive non-lethal defense system. Once a system is designed for a particular installation, it can be replicated and modified quickly using readily available products. The positive aspects of this system greatly reduce the likelihood of mass injuries during an attack event.

This Summary is provided to introduce a selection of concepts in a simplified form that are further described below in the Detailed Descriptions. This Summary is not intended to identify key features or essential features of the claimed subject matter, nor is it intended to be used to limit the scope of the claimed subject matter. These and various other features and advantages will be apparent from a reading of the following Detailed Descriptions.

### BRIEF DESCRIPTION OF THE DRAWING

FIG. 1 is a schematic diagram of a passive defense system.

FIG. 2 is a diagram of an interior space, particularly a hallway, having various light sources of the defense system mounted on the walls.

FIG. 3 is a photograph of an interior space, particularly a recessed doorway, having various light sources of the defense system mounted on the walls and proximate the door.

### DETAILED DESCRIPTION

Described herein is a defense system, particularly adapted for reducing the catastrophic results from an attacker or aggressor (e.g., a criminal or active shooter) inside a building or other structure. The defense system utilizes weaponized light to slow down, dissuade, disorient, and/or at least temporarily incapacitate the attacker or aggressor. Additionally, the defense system provides a virtual shield, allowing potential targets to escape.

The defense system utilizes weaponized lighting, which can cause pain, elicit specific motor responses and affect psychological processes to such an extent to at least temporarily disable and/or incapacitate any attacker(s) or aggressor(s). The effects of these types of lights are purposely dangerous and can cause temporary blindness, disorientation, seizures, and physical discomfort to the viewer. By including weaponized lighting, the defense system can reduce or prevent attacks, or at least reduce and hopefully prevent casualties.

The defense system utilizes bright light (e.g., visible light) that can invoke physical pain reflexes and responses. The longer the duration of exposure to bright lights, the more the viewer will suffer from reduced vision capabilities. The defense system also utilizes strobe effects (e.g., 5-30 HZ) that can cause seizures, disorientation, and in some cases, physical immobilization to the viewer. It is noted that, in some instances, prolonged exposure may cause permanent eye damage.

Not only do the bright lights of the defense system physically slow down, dissuade, disorient, and/or at least temporarily incapacitate the attacker(s), but by placing the lights between the attacker(s) and potential targets, with the lights directed toward the attacker(s), the targets are hidden, providing an opportunity to flee, escape or hide.

The defense system is configured to activate upon a triggering event. The system may be triggered from any room (e.g., classroom or other location) by, for example, manual activation (e.g., a call box or a fire alarm pull) or automatic activation (e.g., by an audible detection system, such as a qualified gunshot detection system). Both manual activation mechanisms and automatic activation mechanisms can be located throughout the building being protected. In some implementations, a manual activation mechanism may be removed from the building, for example, in an adjacent or other location.

Activation of the system overrides any interior lighting, including normal lighting and optionally emergency lighting, causing near-blackout conditions in desired locations such as traffic areas such as hallways and common areas.

The system allows for sectional or compartmentalized operation based on established zones. When the system is activated, at least one zone will activate, depending on the location of the triggering event. Zones can be centrally administered or can be controlled in a distributed manner.

The system includes an override capability, which can be activated by administration and/or law enforcement. The override can be managed on-site or remotely.

Personnel involved in any way with the system (e.g., building personnel such as school administrators, staff, teachers, students; employees, management, supervisors; law enforcement; first responders; etc.) can be trained on the operation, use, and testing of the system. Such training can be in conjunction with ALICE techniques.

In the following description, reference is made to the accompanying drawing that forms a part hereof and in which is shown by way of illustration at least one specific implementation. The following description provides additional specific implementations. It is to be understood that other implementations are contemplated and may be made without departing from the scope or spirit of the present disclosure. The following detailed description, therefore, is not to be taken in a limiting sense. While the present disclosure is not so limited, an appreciation of various aspects of the disclosure will be gained through a discussion of the examples, including the figures, provided below. In some instances, a reference numeral may have an associated sub-label consisting of a lower-case letter to denote one of multiple similar components. When reference is made to a reference numeral without specification of a sub-label, the reference is intended to refer to all such multiple similar components.

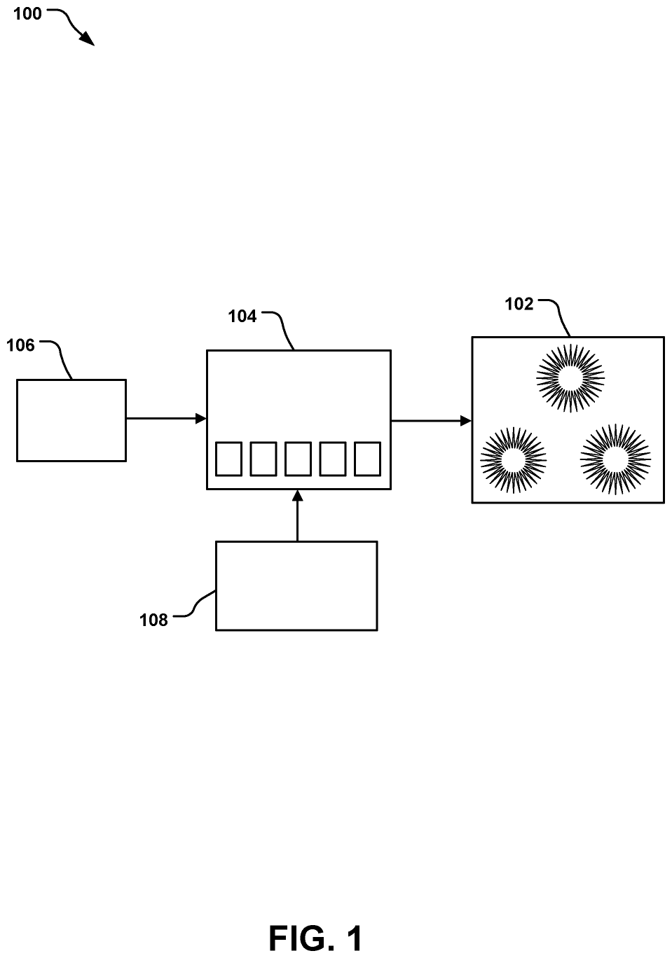

As indicated above, the weaponized light defense system of this disclosure includes a control system, having an activation system, and a multitude of light sources. Turning to FIG. 1, a defense system 100 is schematically shown, having a light source 102 composed of a plurality of lights, that is controlled by a control system 104. The control system 104 includes an activation system 106 and an override system 108, which may be part of or integral with the control system 104 but are shown here separately to facilitate understanding of the elements of the defense system 100. Each of the activation system 106 and the override system 108 are operably connected to the control system 104, which is operably connected to the light source 102; these connections may be any suitable connections, including hard wiring or wireless connection such as Wi-Fi, cellular, Bluetooth, or any other wireless communication protocol.

The light source 102 includes a plurality of high intensity lights that are controlled (e.g., activated) by the control system 104. Each light may be controlled individually, all may be controlled together, or multiple groupings composed of multiple lights may be controlled. Each light can be programmed either directly or indirectly. For example, LED lights can be programmable by individual addressable LED emitters or by whole unit (e.g., spot, flood). Non-addressable lights, such as XENON arc lamps, can be controlled by a power circuit.

The lights may be any or all of LED lighting, XENON lighting, XENON strobes, XENON arc ceramic lamps, visible laser(s), and optical concentrators. The lights may be bulbs, strips, flood lights, etc. The lights in the light source 102 provide high levels of lumens, candela, and lux which can exceed, e.g., 5000 Kelvin (K). Even though not a true light source, the use of shadow play or reflective surfaces can further impact attacker(s) or aggressor(s).

The entire collection of light sources 102, in an area, should provide a light intensity of at least 20,000 lumens, in some embodiments at least 25,000 lumens, and in other embodiments at least 30,000 lumens. As an example, a suitable debilitating light intensity is about 25,000 lumens at 12 feet. As another example, a suitable debilitating level of illumination in a hallway is about 15,000 lux. Additional details regarding suitable lights and their placement in the protected building are provided below.

The lights are placed at designated locations within common areas and traffic areas of the building (e.g., school), the locations selected based on the physical structure of the building, the output of the particular lights, and the area to be illuminated. Wall mounts, semi-recessed ceiling mounts, recessed floor installations, and adhesive based applications can be used to install the lights. The lights are located in locations best suited to provide an impairing light barrier between a potential threat (attacker(s), aggressor(s)) and the persons within the building. The lights can be placed to illuminate public or community areas, in traffic lanes such as hallways, particularly, hallway intersections, and outside of room entries. Specific examples of light source locations include visible wall spaces at ends of hallways, walls and ceiling joints (run linearly with joint) in hallways and common areas, ceilings and walls at strategic locations, in the floor (e.g., transparent floor tiles or embedded in the floor), behind glass or other transparent structure (e.g., in walls, display cases, at doorways), free-standing large light units, and mobile hand units.

The control system 104 activates the lights of the light source 102. As indicated above, the lights may be controlled individually or as a group of lights. The control system 104 may merely turn on the light(s), may pulse the light(s), may strobe the light(s), etc. as programmed in the control system 104. The control system 104 has appropriate hardware and software, including modules, circuitry, code, programming, etc. and at least one processor that implements the various modules of code stored in a non-transitory readable memory (e.g., computer memory) to activate (turn on) and deactivate (turn off) the light sources 102 of the system 100 when requested. The software or code can accommodate any or all of user accounts, lighting control, power control to exiting lighting, system logs, system test parameters, remote access and control, and includes security to protect the digital components. The control system 104 can include one or more controllers, e.g., sub-system controllers such as 64-bit microcontroller cards, and various peripherals such as switches, motors, displays, overrides, connection assemblies, electrical wiring, and data wiring. Redundant control modules, code, circuitry, switches, and the like may be present in the control system 104.

The control system 104 also includes an appropriate input to allow modification of the program of, e.g., zones, lights, light sequences, etc., and any other system features.

The control system 104 may also deactivate the normal lighting fixtures and any emergency lighting when the defense system 100 is activated. Removing any lights that are not part of the light source 102 increases the effect of the defense system 100.

The control system 104 can be located at any location with the building be protected or remote from the building, for example, at a school district administration building, a maintenance building, at a data center, or at any remote location. The location of the control system 104 should be determined taking into account the mechanism of connection of the control system 104 to the light source 102 and to the activation system 106 (e.g., hard wired, Wi-Fi, etc.) and the distance between the control system 104 and the building being protected. The control system 104 can be powered by conventional 110V/120V or 220V/240V A/C, may be battery powered, or may be wirelessly powered. In some implementations, redundant power is provided to the control system 106 and/or the activation system 106.

The activation system 106 is operably connected to the control system 104 to activate the control system 104 to control (e.g., activate) the defensive (weaponized) lights of the system 100. The activation system 106 includes physical, electronic, and/or virtual switches to activate the control system 104 and thus the light source 102 of the weaponized lighting system 100. Examples of physical switches are a call box, a pull switch similar to a fire alarm pull, and a panic push-button. An example of an electronic switch can be web-based or mobile app-based. The activation system 106 also includes virtual panic buttons to active the control system; an example of a virtual panic button is an audible system, such as a qualified gunshot detection system.

The activation system 106 can include a centralized control, such as at the building's office or security center; this centralized control can be a manual system (e.g., a push button or computer activated) or an electronic or virtual activation, such as one that can be activated remotely, e.g., by maintenance, school administrators, law enforcement, via electronic mechanisms (e.g., computer). Additionally, the activation system 106 can include localized manual activation buttons, (e.g., push buttons or panic button) distributed throughout the building, for example, in classrooms, common areas, hallways, etc.

The activation system 106 can be configured to have the control system 104 activate all the lights in the entire system 100, or the activation system 106 can be configured to activate only certain zones (e.g., those zones in the proximity of the panic button used for the activation), or the activation system 106 can be configured to allow the user (activator) to select which zones of the system to activate.

The system 100 also includes the override system 108 to deactivate one or all of the zones; such an override feature is intended to be accessible only to authorized users. The override system 108 can be used from a location remote from the control system 104, such as an admiration building, police station, a mobile command center, to inactivate the system 100. The override system 108 may be one or more manual switches or may be fully electronic.

The light source 102 of the system utilizes lights that can readily be retrofitted into essentially any building constructions. The interior of almost any building can be adapted to support weaponized light with no structural changes or modifications. Depending on the connectivity mechanism between the light source 102, the control system 104 and the activation system 106 and the override system 108, wiring may need to be fed through walls, floors, or ceiling, however such construction is typically minor. Some cosmetic changes are expected, as many of the components of the light source 102 will be visible to the average observer. Additionally, some lights will be recessed, requiring some modification. In general, however, the defense system 100 can be installed and implemented in most buildings and schools without structural changes. Most adaptations can be retrofitted into any existing building design without major renovations.

Although internet access is not required for operation of the system 100, internet is recommended for remote access and control of the system 100. The control system 104 can run the system 100 with a non-standard IP port for remote access. In addition to or alternately to internet, a private intranet, e.g., a Class A IPv4 network, can be utilized.

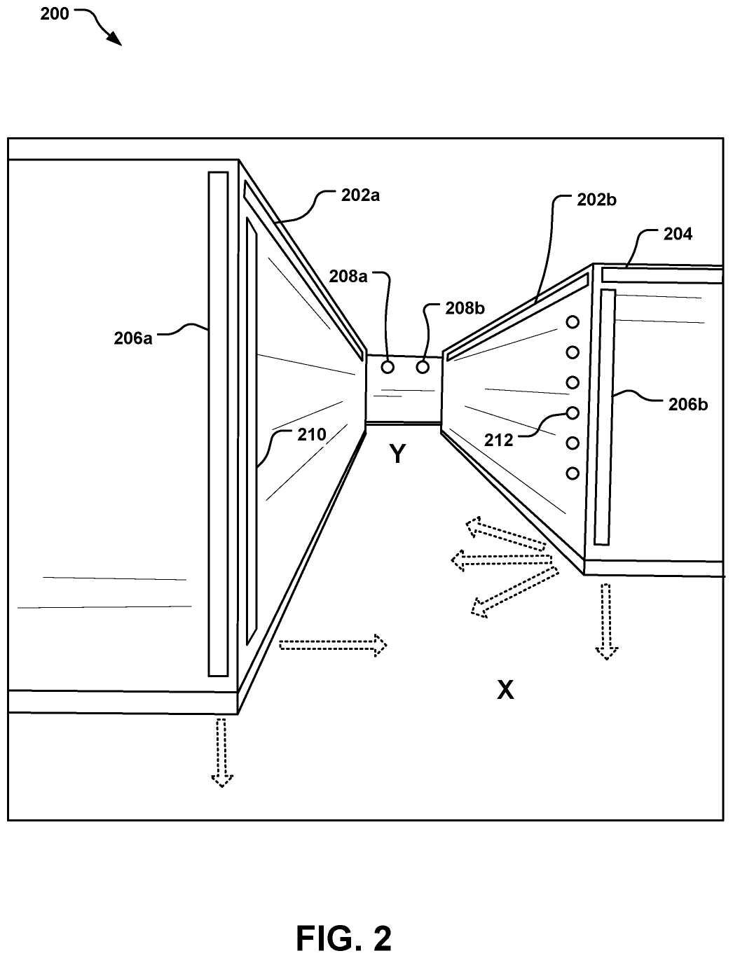

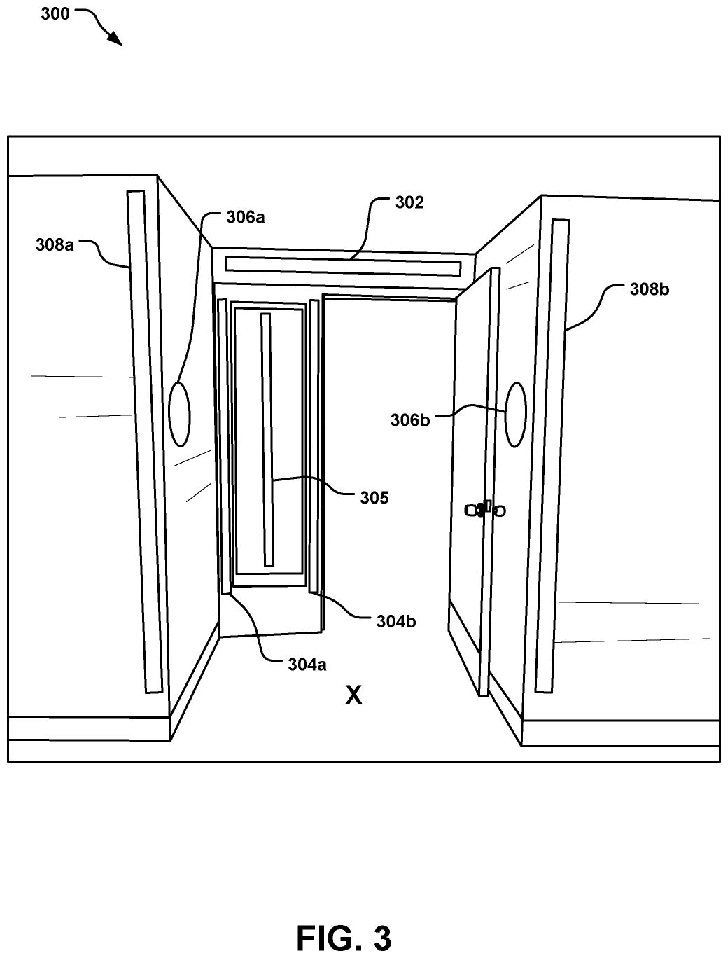

FIGS. 2 and 3 show two examples of installation of the light source portion of the defense system at two different interior locations.

In FIG. 2, a hallway is shown. In particular, a short hallway intersects with another hallway at the far end of the figure, the short hallway forming a T with the other hallway. At the other end of the short hallway (at the end closer to the view), the short hallway intersects with two other hallways, which are not axially aligned; this intersection may be a four-way intersection or a modified-T. This short hallway has installed thereabout a light system 200, which, when combined with a control system and an activation system, forms a defense system. The system 200 includes at least one type of light source (e.g., LED, XENON, laser, optical concentrators, etc.), but generally includes at least two types of light sources (e.g., LED and XENON). This particular system 200 utilizes three types of light sources.

For this short hallway, the light system 200 has upper LED light strips 202a, 202b extending along the length of the hallway close to the top of the wall, near the ceiling; these LED light strips 202a, 202b are on opposites walls of the hallway, and thus pointing toward each other. The system 200 also has another LED light strip 204, extending near the ceiling of the intersecting hallway. Additionally, the system 200 has vertical LED light strips 206a, 206b, and 210 extending along the wall height. The LED light strips 206a, 206b are on the wall of the intersecting hallway whereas the LED strip 210 is on the wall of the short hallway; thus, the strips 206 illuminate predominantly into the intersecting hallways, as shown by the dashed arrows, and the strip 210 illuminates predominantly into the short hallway and down the hallway to the right, as shown by the dashed arrow. Any or all of these LED light strips 202, 204, 206, 210, when activated, may be continuous “on,” may flash, pulse, or be strobed. Strategic locations for LED lighting include at the intersection of walls and ceilings running with the joint and visible wall areas at the ends of hallways. Additional LED light strips may be added in the short hallway, depending on e.g., the length of the hallway, the width of the hallway, and the illumination provided by each light. LED lighting has some limitations to length of run while providing high lumens; thus, more shorter length LED strips may be preferred toyer less longer length LED strips.

The system 200 also has XENON lights 208a, 208b at the terminal end of the short hallway, on the wall of the rear T hallway. These XENON lights 208, when activated, may be continuous “on” or may be strobed. If strobed or pulsed, the lights 208 may alternate. Strategic locations for XENON strobes include at the end of hallways and in open spaces.

The system 200 also has XENON ceramic arc flood lamps 212 spaced vertically on a wall of the short hallway, near the corner. These XENON ceramic arc flood lamps 212, when activated, may be continuous “on” or may be strobed. If strobed or pulsed, the lights 212 may alternate. The multiple XENON flood lamps 212 illuminate a wide angle, up to 120 degrees as shown by the dashed arrows, or even up to 180 degrees from the wall. In alternate implementations, the lights may illuminate around the corner. Strategic locations for ceramic arc lamps include at the end of hallways and in open spaces.

A suitable intensity of the light, when activated, is about 25,000 lumens at 12 feet. As another example, a suitable level of illumination in a hallway is about 15,000 lux.

A viewer, when standing at the location marked X in FIG. 2, which is in the intersection of the three and possibly four hallways, will be exposed directly to the lumens from the LED strip lights 204, 206b, 210 and the ceramic arc flood lights 212, and indirectly to the LED strip lights 202. At the location X, the viewer is surrounded by the various light sources, which may incapacitate but at least disorient the viewer, thus inhibiting movement to and through the short hallway. As the viewer does move down the short hallway to the location marked Y, the viewer will be exposed directly to the lumens from the LED strip lights 202 and the XENON lights 208. At the location Y, the viewer is surrounded by the various light sources, which may incapacitate but at least further disorient the viewer, thus inhibiting further movement through the short hallway to the next hallway. At any location, particularly at the location X and the location Y, the viewer is exposed to at least 25,000 lumens.

As the viewer moves down the short hallway from the location X to the location Y, the LED strips 206 are less effective on the viewer and can be deactivated, e.g., to allow security persons to approach the area.

In FIG. 3, an entry door into a room, recessed from a hallway, is shown. The entry door includes a side light or window. This entry door has installed thereabout a light system 300, which, when combined with a control system and an activation system, forms a defense system. The system 300 includes at least one type of light source (e.g., LED, XENON, laser, optical concentrators, etc.), but generally includes at least two types of light sources (e.g., LED and XENON).

For this entry, the light system 300 has an upper LED light strip 302 extending across the entry door close to the top of the wall, near the ceiling, and LED light strips 304a, 304b extending vertically along the side light, adjacent to the door. A single LED light strip 305 extends vertically on the side light. The system 300 also has a pair of LED light strips 308a, 308b, extending vertical along the wall in the hallway. All of the LED light strips 302, 304, 305, 308 point out, away from the entry door. Any or all of these LED light strips 302, 304, 305, 308, when activated, may be continuous “on,” may flash, pulse, or be strobed. The LED strips 304 and 305, in particular, inhibit a viewer from seeing through the side light into the protected room. Strategic locations for these LED lights include on or near glass or other transparent areas around or near doors, at the intersection of walls and ceilings running with the joint, and vertical wall areas at the ends of hallways. Additional LED light strips may be added in the recessed entry, depending on e.g., the depth of the recess, the width of the door, and the illumination provided by each light.

The system 300 also has XENON lights 306a, 303b on opposite walls of the recessed entry. These XENON lights 306, when activated, may be continuous “on” or may be strobed. Strategic locations for XENON strobes and lamps include on the walls of hallways, open spaces, and above doorways.

A viewer, when standing at the location marked X in FIG. 3, which is in the recess from the hallway, directly in front of the entry door, will be exposed directly to the lumens from the LED strip lights 302, 304, 305 and the XENON lights 306. Prior to arriving at the location X, the viewer would have been directly exposed to the LED strip lights 308. At the location X, the viewer is surrounded by the various light sources, which may incapacitate but at least disorient the viewer, thus inhibiting movement closer to the entry door and through the door. At any location in the recess, particularly at the location X, the viewer is exposed to at least 25,000 lumens.

The LED strips 302, 304, 305 and the XENON lights 306 are oriented to dissuade a viewer (e.g., aggressor) from heading toward the door. Depending on the lumens and lux of the lights, the lights may be temporarily blinding to the person.

Thus, two particular examples of arrangements of defensive light systems have been shown. As indicated above, the weaponized light defense system of this disclosure includes a control system, having an activation system, and a multitude of light sources. See, e.g., FIG. 1 where the defense system 100 has light sources 102, a control system 104, an activation system 106 and an override system 108. The activation system activates the defense system; particularly, the activation system activates the control system which activates the light sources. The defense system may include an override feature that can be used from a location remote from the control system to inactivate the system; such an override feature is intended to be accessible only to authorized users. The lights, however, are the paramount feature of the defense system.

The intent of the type of light sources and the placement of the light sources, and their configurations (e.g., strobe or constant on) is to cause an imbalance in the viewer's (aggressor(s)′) brain, causing confusion and possible physical instability and incapacity. The light arrangement also temporarily blinds the aggressor, inhibiting the aggressor(s)′ ability to target and to even proceed through the area.

As indicated above, although the light systems can include at least one type of light source, they generally include at least two types of light sources. Any or all of the light sources, when activated, may be continuous “on,” may flash, pulse, or be strobed. The light sources may be high intensity, focused, or may be wide-angle, floods.

The light sources may be any or all of LED lighting (e.g., LED strips), XENON lighting, XENON strobes, XENON arc ceramic lamps, and visible laser(s). The lights may be bulbs, strips, flood lights, etc. Optical concentrators, mirrors and reflective surfaces can be included to redirect, better direct, or focus the light. Laser lights can be configured to move, e.g., randomly or in a search-style pattern. In addition to the light sources mounted (fixed) to interior surfaces, such as shown above, portable light units may be used. High intensity hand-held light units can be located in various rooms, e.g., to be used by staff.

The lights in the light source provide high levels of lumens, candela, and lux which can exceed, e.g., 5000 Kelvin. A suitable intensity of the lights is about 25,000 lumens at 12 feet. As another example, a suitable level of illumination in a hallway is about 15,000 lux. Larger spaces, such as common areas, will benefit from higher levels.

The lights are preferably placed to not only illuminate the entire area, but to provide a light barrier between the viewer (e.g., aggressor(s) or attacker(s)) and any building personnel. Strategic locations for LED lighting are on glass or other transparent areas around or near classroom doors, at the intersection of walls and ceilings running with the joint, or visible wall areas at the ends of hallways. LED lighting has some limitations to length of run while providing high lumens; thus, more shorter length LED strips may be preferred that less longer length LED strips. Strategic locations for XENON strobes and ceramic arc lamps include at the end of hallways, open spaces, and above doorways.

The energy to power the light sources can be conventional 110V/120V or 220V/240V A/C, based on the light source requirements and the available energy. Strobes and optical concentrators can operate on typical 120V A/C systems in most cases. As an example, a 120V system providing 20 kW is sufficient for many systems. In some buildings, upgrading power may be needed; for example, new wiring for control and/or power may need to be installed. Some light sources may be battery powered, or at least battery back-up. Depending on the technology of the light source, it may be wirelessly powered, or at least wireless controlled. In some implementations, redundant power sources are provided to the light sources.

The light sources are mounted at strategic locations throughout the protected area (e.g., building interior). The light sources are installed in traffic locations (e.g., hallways) to inhibit an aggressor/attacker from moving throughout the building. The light sources are further installed in locations between the traffic locations (e.g., hallways) and areas where potential targets congregate (e.g., classrooms). The light sources are placed to brightly illuminate the area, and, depending on the type of lighted, directed to shine the direction from which aggressor(s) or attacker(s) may come, thus producing a blinding light toward the incoming aggressor(s) or attacker(s).

In most installations of the system, the light sources are the only exposed component. Being a key component of the system, the light sources are preferably contained in or behind high impact resistant (e.g., bullet-proof) cases or shells. Alternately, or even additionally, the light sources can be affixed in a hard-to-target location or other location that requires precision targeting.

The entire collection of light sources, in an area, should provide a light intensity of at least 20,000 lumens, in some embodiments at least 25,000 lumens, and in other embodiments at least 30,000 lumens. Each of the light sources is able to provide at least 2,000 lumens. Preferred lights or light sources generate more than 1,000 lumens per linear foot or a single spot light. The lights can be high-intensity high-output lights that create a physically painful effect on human eyes. It should be noted that a “light source” may be made up of several smaller lights that are located in very close proximity to each other and together provide at least 2,000 lumens directed to a focal point.

Lumens is the measurement of how much light is obtained from a bulb or other light source. A higher lumens relates to a brighter light compared to fewer lumens that represents a dimmer light.

A lux is unit of illumination and is proportional to a lumen. One lux equals 1 Lumen/m²; in other words, light intensity in a specific area. Lux is used to measure the amount of light output in a given are; it enables us to measure the total “amount” of visible light present and the intensity of the illumination on a surface.

Kelvin (K) is a unit of measurement used to describe the hue of a specific light source. This is not necessarily related to the heat output of the light source but rather the color of the light output.

Table 1, below, lists various light sources and their properties, for use in the defense system of this disclosure.

TABLE 1

| | Lumens | Kelvin | Lux |
|---|---|---|---|
| LED | 3,000-4,000 | 5,000 to >6,000 | 3,000-4,000 |
| XENON | 25,000 | 5,000 to >6,000 | 25,000 |
| Laser | 532-445 nm wave length - Class IIIb or IV | | |
| Incandescent | Not recommended | | |
| Optical | 10,000-15,000 | 5,000 to >6,000 | |
| concentrator | | | |

As shown above, the light sources can be present on vertical surfaces (e.g., walls) or on horizontal surfaces (e.g., ceiling, floor). The light sources can be present on walls at the end of a hall, at wall to ceiling joints, on walls or windows proximate to a door or doorway, recessed into the floor or ceiling, mounted on or hanging from the ceiling, and various other locations. Light sources may be portable and/or moveable. Light sources should be placed so that the aggressor(s)′ face is brightly illuminated; for example, lights on vertical surfaces can be about 5 to 6 feet from the floor, lights on a ceiling can be angled rather than pointing straight down, and light strips can run vertically; all of these orientations can have the light shine in the aggressor(s)′ eyes.

Table 2, below, provides examples for light source location based on the light source type.

TABLE 2

| Type | Location | Placement |
|---|---|---|
| Elongate strip | Horizontal joints | Wall/ceiling joints |
| | Vertical walls | Walls, wall corners |
| | Glass panels | Glass panes (placed |
| | | to face outwards from |
| | | target toward aggressor(s)) |
| Spot/Flood | Recessed doors | 4 to 8 around doorways, |
| | or doorways | openings |
| | Walls | Vertical face at end of |
| | Free standing | hallway |
| | wall/bank | Portable wall/bank |
| | | moveable to protect areas |

For LED lighting, the targeted placement of these is on or next to glass or other transparent areas around or near doors, windows or other areas providing visual access to an area, at the intersection of walls and ceilings running with the joint, or visible wall areas at the ends of hallways.

XENON lights, either or both flood lights or spot lights, can be placed at the end of hallways (the light pointing back into the hallway), on walls in open spaces, and above doorways. Use of shadow play or reflective surfaces can further impact the aggressor.

XENON strobe lights can similarly be placed at the end of hallways (the light pointing back into the hallway), on walls in open spaces, and above doorways. Use of shadow play or reflective surfaces can further impact the aggressor.

Laser lights can be included in the defense system. These can be deployed randomly in a search-style pattern or combined with facial recognition technology via security cameras. Any lasers may be continuous “on” or may strobe.

Optical concentrators can be mounted in locations to focus light from the other light sources on a location that is not readily doused in light by the light sources. Additionally or alternately, portable hand-held optical concentrators may be readily available for use by staff, law enforcement, and emergency personnel.

Numerous other installations and configurations of the light sources on and around the walls, ceiling, floor, window, etc. could be used. Also, banks of lights mounted on a frame may be used as a portable wall for large, infrequently used areas, e.g., pool, gym, etc. Such banks can be designed to provide a defensive wall of blinding light behind which persons can hide.

The passive defense system of this disclosure includes a multitude or plurality of light sources. The light sources may be all of the same type (e.g., all LEDs) or the light sources may be a collection of multiple light sources (e.g., two XENON strobe lights, four LED strip lights, and one XENON flood light).

The lights of the passive defense system can be separated into separate zones, for example, north end of the building, south end of the building, second floor, first floor, etc. When the system is activated, at least one zone will activate, depending on the location of the activating input or the triggering event. In some embodiments, the control system may activate multiple zones, depending on the location of the triggering event. For example, if the trigger event is close to an edge of a zone, that zone plus the adjacent zone may be activated. As another example, if it is known the aggressor entered the building through the south is moving east and north, zones forming a perimeter around the aggressor's location can be activated.

Table 3, below, provides a summary of exemplary parts and features of the control system suitable for a school. The control system can have localized, centralized, and remote activation of the system by different types of activation items located at different areas, via various communication connections.

TABLE 3

| Activation | Activation | | | Minimum |
|---|---|---|---|---|
| Mode | Type | Location | Connection | Quantity |
| Localized | Panic | Classroom | Hardwire | Varies - |
| | Button/ | Common | Wireless | dependent on |
| | switch | area | | number of |
| | Callbox | | | localized |
| | Web | | | installations |
| | (Internet) | | | |
| | Fob with | On person | Wireless Fob | |
| | sensor | | Hardwired | |
| | | | Sensor | |
| Centralized | Master Control | Main Office/ | Direct | 1 |
| | Station | Security | interface | |
| Remote | Law | Web | HTTPS with | 1 |
| | Enforcement | (Internet) | private port | |
| | System | Web | HTTPS with | 1 |
| | Provider | (Internet) | private port | |

The master control station includes the ability to activate the defense system (via the activation system), the ability to shutdown existing lights in conjunction with and/or independent of system activation, allows authorized remote control, uses standard computer interfaces (e.g., keyboard, mouse, monitor or display), and may have various physical lights and buttons to operate the control station. The control station can activate all lights, a single light, multiple individual lights, single group of lights, or multiple groups of lights, either automatically or via manual activation or override.

It is noted that due to the unpredictable nature of attacks (e.g., school attacks, workplace attacks) and their attacker(s), it is impossible to ensure the safety of all people, whether authorized to be in the location or not, when the defense system is deployed. Persons not in protected areas may be affected by the system resulting in the inability to identify and move to safety. Steps should be taken on methods of training to support minimizing the effects if caught in an activation event. Any training will need to bear in mind the potential attacker may also be present at the training and be provided information on minimizing the effects.

While not intended to be installed in rooms where people regularly congregate (e.g., classrooms), with the exception of covering entries to those rooms, the defensive system is intended to be deployed in hallways, common areas, restrooms, service areas and points of building ingress and egress. The system is best suited for protecting persons in rooms (e.g., classrooms) from attacker(s)/aggressor(s) present in common areas such as hallways.

In summary, described herein are defense systems for building interiors that utilize a plurality of high intensity lights and strobe effects to at least temporarily physically and detrimentally affect potential attacker(s) and aggressor(s). Of course, lights alone will not resolve the entire situation. Protection of students and normal occupants of the building and the security force entering the premises is also paramount. When a defense system, as described above, is used in conjunction with other safety measures, such as locked or controlled entrance doors and/or metal detectors, the likelihood of tragic attacks is greatly reduced.

The above specification and examples provide a complete description of the structure and use of exemplary implementations of the invention. The above description provides specific implementations. It is to be understood that other implementations are contemplated and may be made without departing from the scope or spirit of the present disclosure. The above detailed description, therefore, is not to be taken in a limiting sense. While the present disclosure is not so limited, an appreciation of various aspects of the disclosure will be gained through a discussion of the examples provided.

Unless otherwise indicated, all numbers expressing feature sizes, amounts, and physical properties are to be understood as being modified by the term “about,” whether or not the term “about” is immediately present. Accordingly, unless indicated to the contrary, the numerical parameters set forth are approximations that can vary depending upon the desired properties sought to be obtained by those skilled in the art utilizing the teachings disclosed herein.

As used herein, the singular forms “a”, “an”, and “the” encompass implementations having plural referents, unless the content clearly dictates otherwise. As used in this specification and the appended claims, the term “or” is generally employed in its sense including “and/or” unless the content clearly dictates otherwise.

Spatially related terms, including but not limited to, “bottom,” “lower”, “top”, “upper”, “beneath”, “below”, “above”, “on top”, “on,” etc., if used herein, are utilized for ease of description to describe spatial relationships of an element(s) to another. Such spatially related terms encompass different orientations of the device in addition to the particular orientations depicted in the figures and described herein. For example, if a structure depicted in the figures is turned over or flipped over, portions previously described as below or beneath other elements would then be above or over those other elements.

Since many implementations of the invention can be made without departing from the spirit and scope of the invention, the invention resides in the claims hereinafter appended. Furthermore, structural features of the different implementations may be combined in yet another implementation without departing from the disclosure or the recited claims.

What is claimed is:

1. A non-lethal defense system comprising:
a plurality of light sources, each source providing at least 2,000 lumens and the plurality of light sources providing at least 20,000 lumens and 20,000 lux at a distance of 15 feet, the plurality of light sources configured for installation in an interior of a building;
a control system comprising a processor stored in a memory for controlling the operation of the plurality of light sources; and
an activation system operably connected to the control system to activate the control system upon a triggering event, the activation system including an input feature to receive the triggering event.

2. The defense system of claim 1, wherein the input feature is a physical switch, an electronic switch, or a gunshot detection sensor.

3. The defense system of claim 1, wherein the plurality of light sources includes at least two of LED lights, XENON lights, laser, and optical concentrator.

4. The defense system of claim 3 wherein the plurality of light sources are LED lights and XENON lights.

5. The defense system of claim 3 wherein one of the at least two light sources is continuously on and a second of the at least two light sources is strobed.

6. The defense system of claim 3, wherein one of the plurality of light sources is a strip of LED lights.

7. The defense system of claim 6, wherein the strip of LED lights is mounted proximate a joint of a wall and a ceiling.

8. The defense system of claim 6, wherein the strip of LED lights is mounted extending vertically on a surface proximate a door.

9. The defense system of claim 3, wherein one of the plurality of light sources is a XENON flood light.

10. The defense system of claim 9, wherein the XENON flood light is mounted on a terminal vertical wall.

11. The defense system of claim 9, wherein the XENON flood light is mounted on a vertical wall proximate a door.

12. The defense system of claim 1, wherein the plurality of light sources configured for installation in a traffic area in the interior of the building.

13. The defense system of claim 1, wherein a first portion of the plurality of light sources define a first zone and a second portion of the plurality of light sources define a second zone, each of the first zone and the second zone independently controllable by the control system.

14. A method of protecting interior space of a building, the method comprising:
positioning a first plurality of light sources in a first zone of the building and positioning a second plurality of light sources in a second zone of the building, each of the light sources providing at least 2,000 lumens and operably connected to a control system;
responsive to a triggering event, the control system activating the first plurality of light sources and the second plurality of light sources to provide at least 20,000 lumens and 20,000 lux at a distance of 15 feet in each of the first zone and the second zone; and
responsive to an override event, the control system deactivating the first plurality of light sources.

15. The method of claim 14, wherein positioning a first plurality of light sources and a second plurality of light sources comprises positioning at least one LED light source and at least one XENON light source in each of the first zone and the second zone.

16. The method of claim 15, wherein activating the first plurality of light sources and the second plurality of light sources comprises strobing the at least one XENON light source.

17. The method of claim 14, wherein positioning a first plurality of light sources comprises positioning the light sources around a door to provide at least 25,000 lumens.

18. The method of claim 14, wherein the triggering event is activation of a manual switch or an electronic switch.

19. The method of claim 14, wherein the triggering event is confirmation by a gunshot detection sensor.

20. The method of claim 14, further comprising, responsive to the override event, the control system further deactivating the second plurality of light sources.
